(19) United States
(12) Patent Application Publication
(10) Pub. No.: US 2008/0308323 A1
(43) Pub. Date: Dec. 18, 2008

(54) Object Location Sensor of Touch Panel

(76) Inventors: Chun-Chung Huang, Hsinchu City (TW); Tsun-Min Wang, Changhua City (TW); Chun-Yu Lin, Daya Township (TW); Tse-Chi Lin, Yonghe City (TW)

Correspondence Address: HDSL, P.O. BOX 220746, CHANTILLY, VA, 20153-0746, US

(21) Appl. No.: 11/971,762

(22) Filed: Jan. 9, 2008

(30) Foreign Application Priority Data
Jun. 14, 2007 (TW) 096121446

(51) Int. Cl. G06F 3/044

(52) U.S. Cl. 178/18.06

(57) ABSTRACT

An object location sensor of a touch panel has at least one capacitive sensing set having two adjacent capacitive sensors. The at least one capacitive sensing set is arranged along a direction, one capacitive sensor has a capacitance value increasing gradually along the direction, and another capacitive sensor has a capacitance value decreasing gradually along the direction.

### FIELD OF THE INVENTION

The present invention relates to object location sensors of touch panels, and more particularly to an object location sensor of a two-dimensional touch panel having a plurality of one-dimensional capacitance sensors.

### DESCRIPTION OF THE RELATED ART

Touch panels are now widely used, such as in tour guide systems, automatic teller machines, point-of-sale terminals, and industrial control systems, etc. Since the touch panels are convenient and durable in using, and have a low cost, the market thereof is in developing.

The touch panels can be classified into three kinds by physical theories for sensing touch points, such as resistive touch panels, capacitive touch panels, and wave touch panels. The resistive touch panels are operated by being pressed by figures or touch heads to produce voltages. The capacitive touch panels are operated by absorbing little currents by the figures (such as the touch panels usually used in notebook computer). The wave touch panels use sound waves or infrared to cover the whole panel and obstruct the waves by the figures or the touch heads.

Referring to FIG. 1, an object location sensor of a touch panel having a plurality of two-dimensional capacitive sensors is shown. In FIG. 1, when the figures or the touch heads press lightly the touch panel, capacitive sensors 12, 14 of the pressed location produce capacitance coupling because of an electric field therein to absorb little current and change the capacitance value. When scanning the whole capacitive sensors 12, 14, which is in the X axis (the first dimensionality) and the Y axis (the second dimensionality), the location of the X axis and the Y axis having the changed capacitance value is a location pressed by the figures or the touch heads and is located. The object location sensor 10 has a structure selected from a group consisted of two-dimensional solid rhombus, hexagon, or other sharps.

The object location sensor may have a structure not only shown in FIG. 1, but also other structures.

What is needed, therefore, is an object location sensor of a two-dimensional touch panel, which employs one-dimensional capacitive sensors to sense the object location of the two-dimensional touch panel.

### BRIEF SUMMARY

An object location sensor of a touch panel in accordance with a preferred embodiment of the present invention includes at least one capacitive sensing set having two adjacent capacitive sensors. The at least one capacitive sensing set is arranged along a direction, one capacitive sensor has a capacitance value increasing gradually along the direction, and another capacitive sensor has a capacitance value decreasing gradually along the direction.

In one embodiment of the present invention, the one capacitive sensor has a capacitance value CXodd when it is touched by an object, and the another capacitive sensor has a capacitance value CXeven when it is touched by the object. The at least one capacitive sensing set has a total capacitance value Ctot when it is touched by the object, and the total capacitance value Ctot is equal to a sum of the capacitance value CXeven and the capacitance value CXodd.

In one embodiment of the present invention, when the object location sensor are scanned to detect one capacitive sensing set having the total capacitance value Ctot, the capacitive sensing set is a first dimensional location touched by the object. A ratio selected from a group consisted of (CXeven-CXodd)/Ctot, CXeven/Ctot and CXodd/Ctot, is used to determine a second dimensional location touched by the object.

In one embodiment of the present invention, the one capacitive sensor has a plurality of strip capacitive branches increasing gradually along the direction to increase the capacitive value thereof, and the another capacitive sensor has a plurality of strip capacitive branches decreasing gradually along the direction to decrease the capacitive value thereof.

In one embodiment of the present invention, the one capacitive sensor has a plurality of triangular capacitive branches increasing gradually along the direction to increase the capacitive value thereof, and the another capacitive sensor has a plurality of triangular capacitive branches decreasing gradually along the direction to decrease the capacitive value thereof.

In one embodiment of the present invention, the one capacitive sensor has a plurality of rectangular capacitive branches increasing gradually along the direction to increase the capacitive value thereof, and the another capacitive sensor has a plurality of rectangular capacitive branches decreasing gradually along the direction to decrease the capacitive value thereof.

In one embodiment of the present invention, the one capacitive sensor has a plurality of annular capacitive branches increasing gradually along the direction to increase the capacitive value thereof, and the another capacitive sensor has a plurality of annular capacitive branches decreasing gradually along the direction to decrease the capacitive value thereof.

Other objects, advantages and novel features of the invention will become more apparent from the following detailed description when taken in conjunction with the accompanying drawings, in which:

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a conventional object location sensor of a touch panel having two-dimensional capacitive sensors.

FIG. 2 is a schematic view of an object location sensor of a two-dimensional touch panel having one-dimensional capacitive sensors in accordance with a first preferred embodiment of the present invention.

FIG. 3 is a graph showing changed capacitance values and total capacitance values of the one-dimensional capacitive sensors.

FIG. 4 is a graph showing different-mode capacitance value of the one-dimensional capacitive sensors.

FIG. 5 is a schematic view of an object location sensor of a two-dimensional touch panel having one-dimensional capacitive sensors in accordance with a second preferred embodiment of the present invention.

FIG. 6 is a schematic view of an object location sensor of a two-dimensional touch panel having one-dimensional capacitive sensors in accordance with a third preferred embodiment of the present invention.

FIG. 7 is a schematic view of an object location sensor of a two-dimensional touch panel having one-dimensional capacitive sensors in accordance with a fourth preferred embodiment of the present invention.

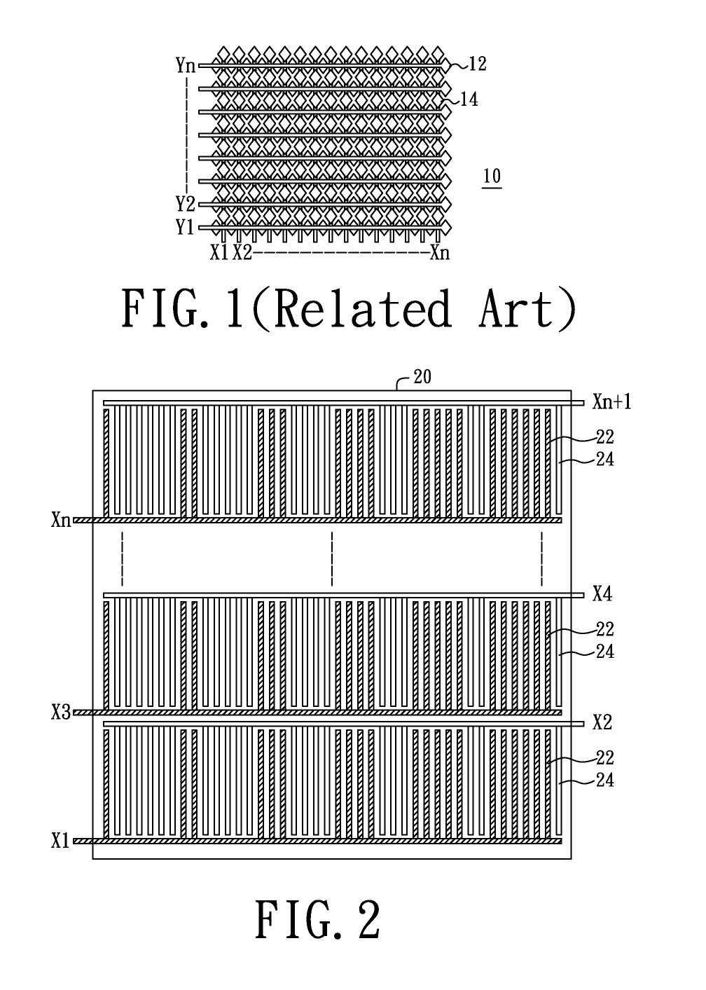

### DETAILED DESCRIPTION

Reference will now be made to the drawings to describe a preferred embodiment of the present object location sensor of touch panel switch, in detail.

Referring to FIG. 2, an object location sensor 20 of a two-dimensional touch panel having a plurality of one-dimensional capacitive sensors, in accordance with a first preferred embodiment of the present invention is shown. In FIG. 2, the object location sensor 20 of the two-dimensional touch panel has a plurality of capacitive sensors X1, X2, . . . Xn, Xn+1, etc. Each of the odd capacitive sensors (X1, X3, . . . Xn) has a plurality of capacitive branches 22, and each of the even capacitive sensors (X2, X4 . . . Xn+1) has a plurality of capacitive branches 24. Furthermore, in this exemplary embodiment, two adjacent capacitive sensors are coupled to form a capacitive sensing set. For example, the capacitive sensors X1 and X2 are coupled to form a capacitive sensing set, and so forth.

In this exemplary embodiment, the capacitive branches 22 of the odd capacitive sensors X1, X3, . . . Xn, etc., are strip and increasing gradually along a horizontal direction (in some different embodiments, the capacitive sensors may be arranged along a perpendicular direction) to increase the capacitive density thereof. On the other hand, the capacitive branches 24 of the even capacitive sensors X2, X4, . . . Xn+1, etc., are strip and decreasing gradually along the horizontal direction to decrease the capacitive density thereof. Since the capacitance value is in direct ratio to the area, the capacitance values of the capacitive branches 22 increases gradually by increasing their areas gradually, and the capacitance values of the capacitive branches 24 decreases gradually by decreasing their areas gradually.

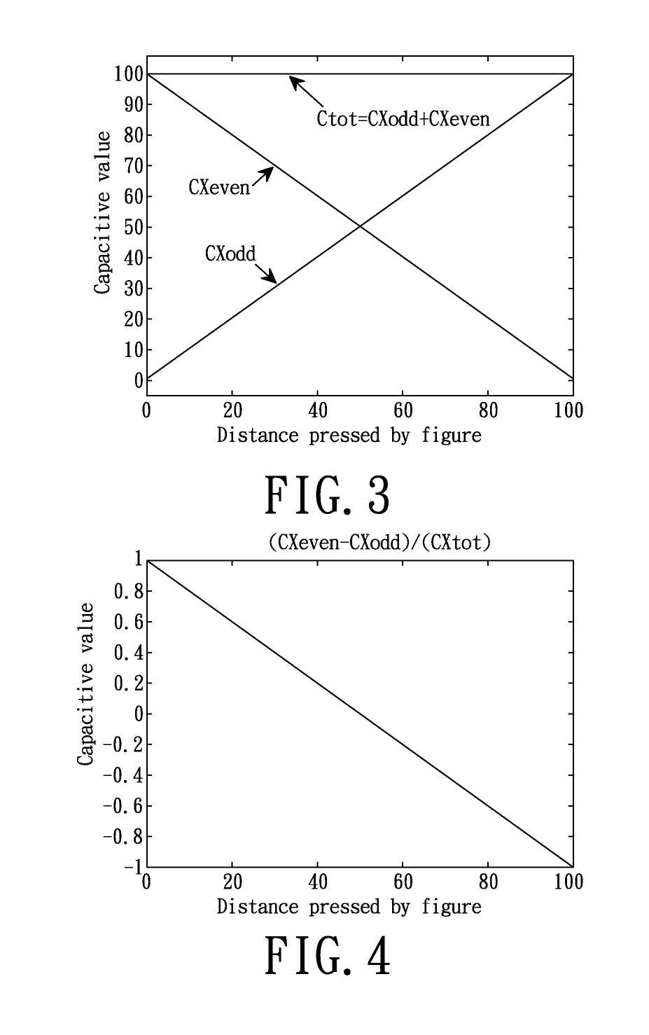

FIG. 3 is a graph showing changed capacitance values and total capacitance values of the one-dimensional capacitive sensors. In FIG. 3, the two capacitive sensors are coupled to be a capacitive sensing set for scanning in series the whole object location sensor 20. For example, the capacitive sensor X3 is scanned to detect a location (the location pressed lightly of the touch panel) of an object (such as the figure), and the capacitance value of the capacitive sensor X3 (the changed capacitance value described in the prior art) is CXodd. Furthermore, the capacitive sensor X4 is scanned to detect the location of the object, and the capacitance value of the capacitive sensor X4 is CXeven.

Therefore, in this exemplary embodiment, when the object touches any capacitive sensing set (such as the capacitive sensors X1 and X2 touched by the object) of the object location sensor 20, a same total capacitance value Ctot can be achieved by being touched at any location in the horizontal direction, and the total capacitance value Ctot is equal to sum of CXeven and CXodd. Furthermore, the total capacitance value Ctot is different from the other total capacitance values of the other capacitive sensing sets (the other capacitive sensors except the capacitive sensors X1 and X2 touched by the object), which are not touched by the object. That is, when the capacitive sensors X1 and X2 are touched by the object, the total capacitance value of the capacitive sensing set composed of the capacitive sensors X1 and X2 is same to that of the capacitive sensing set composed of the capacitive sensors X3 and X4, when the capacitive sensors X3 and X4 are touched by the object. Thus, the first dimensional location of the object (the location of the touched capacitive sensing set), can be located by detecting the total capacitance value of every capacitive sensing set.

FIG. 4 is a graph showing different-mode capacitance values of the one-dimensional capacitive sensors. In FIG. 4, if the object touches the capacitive sensing set composed of the capacitive sensors X1 and X2, when the capacitive sensors X1 and X2 are scanned, ratios such as (CXeven-CXodd)/Ctot, CXeven/Ctot, or CXodd/Ctot can be calculated respectively by using the capacitance values CXeven, CXodd and Ctot of the capacitive sensors X1 and X2, which are touched by the object. The ratios can be used to determine the corresponding location (the second dimensional location of the object) of the capacitive sensors X1 and X2, which are touched by the object. For example, when CXodd/Ctot is 1/3, the location touched by the object is a location of 1/3 of the capacitive sensor X1 from left to right, or the location is a location of 2/3 of the capacitive sensor X2 from right to left.

Therefore, the present invention can use the object location sensor having the one-dimensional capacitive sensors to form a capacitive sensing set by coupling two capacitive sensors, and use the total capacitance values and the different-mode capacitance values of the capacitive sensing sets to detect the two dimensional location of the object at the touch panel.

Based on the above detecting method and principle for detecting the location touched by the object by using the capacitive sensing set, the sharps of the capacitive branches of the capacitive sensing sets can be changed. However, each of the capacitive sensing set is composed of two adjacent capacitive sensors, one capacitive sensor arranged in a direction has a capacitance value increasing gradually along the direction, and another adjacent capacitive sensor has a capacitance value decreasing gradually along the direction. Any sharp of the capacitive branches of the capacitive sensing sets can be used to perform the above detecting method and principle.

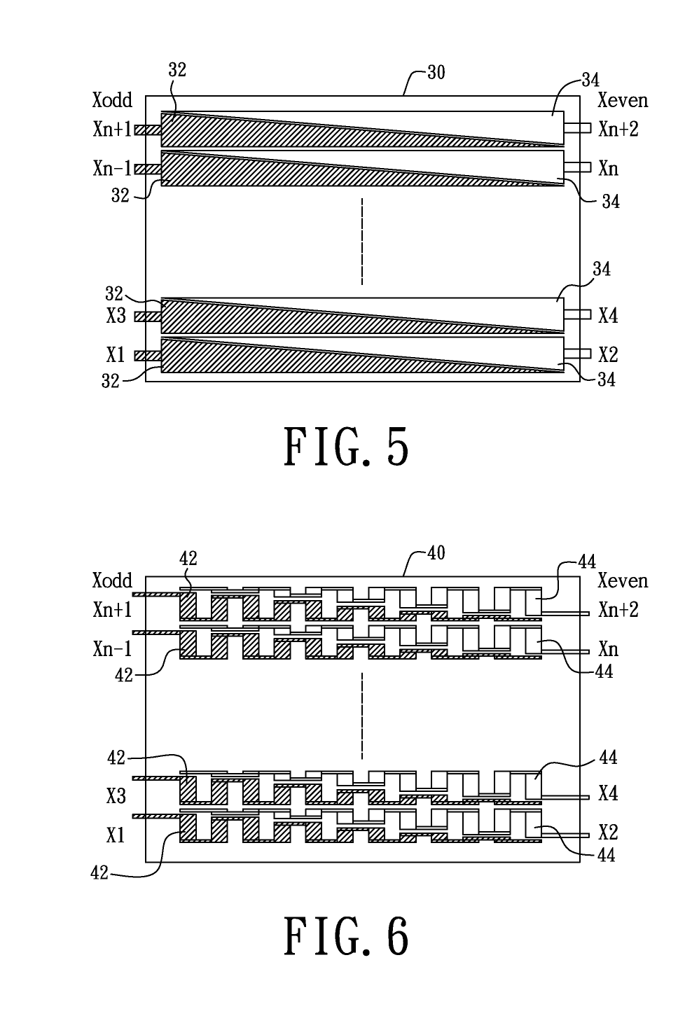

Referring to FIG. 5, an object location sensor of a two-dimensional touch panel having a plurality of one-dimensional capacitive sensors, in accordance with a second preferred embodiment of the present invention is shown. The object location sensor 30 of the touch panel has a plurality of capacitive sensors X1, X2 . . . Xn+1, Xn+2 to form a plurality of capacitive sensing set. For example, the capacitive sensors X1 and X2 are coupled to form a capacitive sensing set, and so on. Each of the odd capacitive sensors X1, X3, . . . Xn+1, which are arranged in a horizontal direction (in some other different embodiment, the capacitive sensors may be arranged in a perpendicular direction), has a plurality of triangular capacitive branches 32, which are increasing gradually to increase the capacitive density thereof. Each of the even capacitive sensors X2, X4, . . . Xn+2, which are arranged in the horizontal direction, has a plurality of triangular capacitive branches 34, which are decreasing gradually to decrease the capacitive density thereof. Since the capacitance value is direct ratio to the area, the triangular capacitive branches 32 have capacitive values increasing gradually by multiplying the area increasing gradually and the changeless capacitive density, and the triangular capacitive branches 34 have capacitive values decreasing gradually by multiplying the area decreasing gradually and the changeless capacitive density.

Referring to FIG. 6, an object location sensor of a two-dimensional touch panel having a plurality of one-dimensional capacitive sensors, in accordance with a third preferred embodiment of the present invention is shown. The object location sensor 40 of the touch panel has a plurality of capacitive sensors X1, X2 . . . Xn+1, Xn+2 to form a plurality of capacitive sensing sets. For example, the capacitive sensors X1 and X2 are coupled to form a capacitive sensing set, and so on. Each of the odd capacitive sensors X1, X3 . . . Xn+1, which are arranged in a horizontal direction (in some other different embodiment, the capacitive sensors may be arranged in a perpendicular direction), has a plurality of rectangular capacitive branches 42, which are increasing gradually to increase the capacitive density thereof. Each of the even capacitive sensors X2, X4, . . . Xn+2, which are arranged in the horizontal direction, has a plurality of rectangular capacitive branches 44, which are decreasing gradually to decrease the capacitive density thereof. Since the capacitance value is direct ratio to the area, the rectangular capacitive branches 42 have capacitive values increasing gradually by multiplying the area increasing gradually and the changeless capacitive density, and the rectangular capacitive branches 44 have capacitive values decreasing gradually by multiplying the area decreasing gradually and the changeless capacitive density.

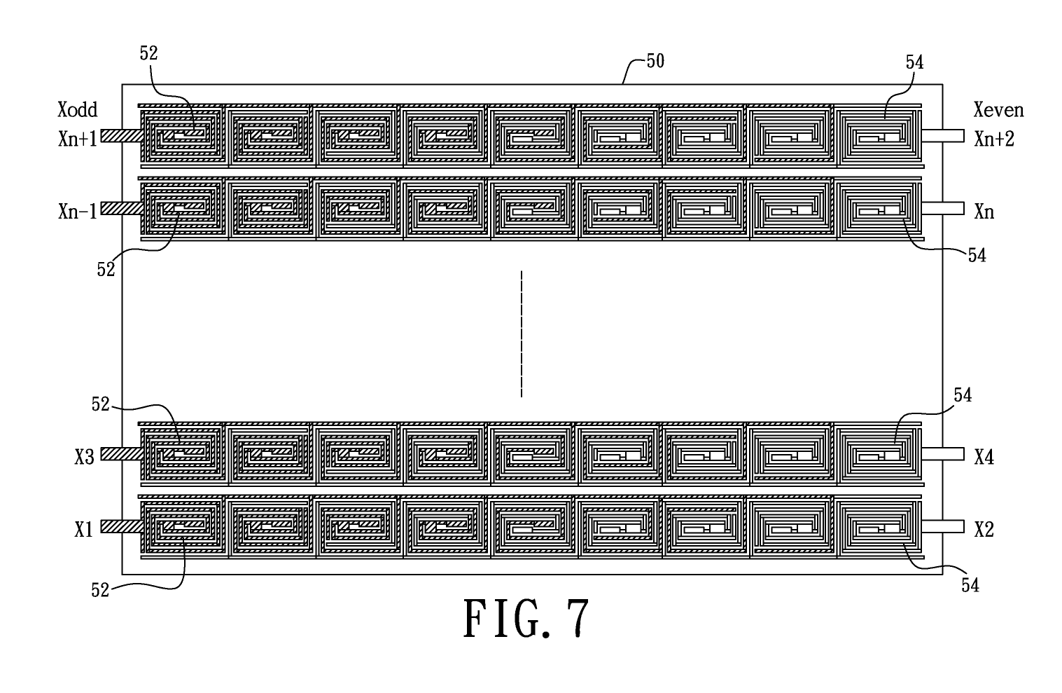

Referring to FIG. 7, an object location sensor of a two-dimensional touch panel having a plurality of one-dimensional capacitive sensors, in accordance with a fourth preferred embodiment of the present invention is shown. The object location sensor 50 of the touch panel has a plurality of capacitive sensors X1, X2 . . . Xn+1, Xn+2 to form a plurality of capacitive sensing sets. For example, the capacitive sensors X1 and X2 are coupled to form a capacitive sensing set, and so on. Each of the odd capacitive sensors X1, X3, . . . Xn+1, which are arranged in a horizontal direction (in some other different embodiment, the capacitive sensors may be arranged in a perpendicular direction), has a plurality of annular capacitive branches 52, which are increasing gradually to increase the capacitive density thereof. Each of the even capacitive sensors X2, X4, . . . Xn+2, which are arranged in the horizontal direction, has a plurality of annular capacitive branches 54, which are decreasing gradually to decrease the capacitive density thereof. Since the capacitance value is direct ratio to the area, the annular capacitive branches 52 have capacitive values increasing gradually by multiplying the area increasing gradually and the changeless capacitive density, and the annular capacitive branches 54 have capacitive values decreasing gradually by multiplying the area decreasing gradually and the changeless capacitive density.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An object location sensor of a touch panel, comprising:
at least one capacitive sensing set having adjacent first and second capacitive sensors, the at least one capacitive sensing set arranged along a direction, the first capacitive sensor having a capacitance value increasing gradually along the direction, and the second capacitive sensor having a capacitance value decreasing gradually along the direction.

2. The object location sensor as claimed in claim 1, wherein the first capacitive sensor has a capacitance value CXodd when the first capacitive sensor is touched by an object, the second capacitive sensor has a capacitance value CXeven when the second capacitive sensor is touched by the object, and the at least one capacitive sensing set has a total capacitance value Ctot when it is touched by the object, the total capacitance value Ctot is equal to a sum of the capacitance value CXeven and the capacitance value CXodd.

3. The object location sensor as claimed in claim 2, wherein when the object location sensor is scanned to detect one capacitive sensing set having the total capacitance value Ctot, the capacitive sensing set is a first dimensional location touched by the object; a ratio, selected from a group consisted of (CXeven-CXodd)/Ctot, CXeven/Ctot and CXodd/Ctot, is used to determine a second dimensional location touched by the object.

4. The object location sensor as claimed in claim 1, wherein the first capacitive sensor has a plurality of strip capacitive branches increasing gradually along the direction to increase the capacitive value thereof, and the second capacitive sensor has a plurality of strip capacitive branches decreasing gradually along the direction to decrease the capacitive value thereof.

5. The object location sensor as claimed in claim 1, wherein the first capacitive sensor has a plurality of triangular capacitive branches increasing gradually along the direction to increase the capacitive value thereof, and the second capacitive sensor has a plurality of triangular capacitive branches decreasing gradually along the direction to decrease the capacitive value thereof.

6. The object location sensor as claimed in claim 1, wherein the first capacitive sensor has a plurality of rectangular capacitive branches increasing gradually along the direction to increase the capacitive value thereof, and the second capacitive sensor has a plurality of rectangular capacitive branches decreasing gradually along the direction to decrease the capacitive value thereof.

7. The object location sensor as claimed in claim 1, wherein the first capacitive sensor has a plurality of annular capacitive branches increasing gradually along the direction to increase the capacitive value thereof, and the second capacitive sensor has a plurality of annular capacitive branches decreasing gradually along the direction to decrease the capacitive value thereof.
